(19) United States
(12) Patent Application Publication
(10) Pub. No.: US 2022/0079266 A1
(43) Pub. Date: Mar. 17, 2022

(54) FACE MASK ATTACHMENT DEVICE

(71) Applicant: Marisa Mason, Cave Creek, AZ (US)

(72) Inventor: Marisa Mason, Cave Creek, AZ (US)

(21) Appl. No.: 17/018,203

(22) Filed: Sep. 11, 2020

(51) Int. Cl. A41D 13/11; G02C 11/00; F16B 2/20

(52) U.S. Cl. CPC A41D 13/1161; F16B 2/20; G02C 11/00

(57) ABSTRACT

A clip for facilitating face mask attachment on an eyewear is disclosed herein. The clip comprises a clip body having a temple attachment portion for facilitating placement of the clip on a temple of an eyewear, and a mask attachment portion extending from the temple attachment portion for securely holding a securing cord of a face mask. In another embodiment, a mask attachment sleeve is disclosed herein. The mask attachment sleeve is configured for assembly on a temple of an eyewear. The mask attachment sleeve comprises a sleeve body, and at least one clip provided on the sleeve body for securely holding a securing cord of a face mask.

### TECHNICAL FIELD

The present disclosure relates generally to a clip, and more particularly, to a clip that allows the user to put on a face mask in conjunction with eyewear with ease and convenience.

### BACKGROUND

It is well known that many respiratory infections can be transmitted through airborne particles. In particular, when in close contact with a person having respiratory symptoms, it is possible that infective respiratory droplets can come into contact with one's nose, mouth, or eyes. Accordingly, health care professionals are educated to wear face masks and to supply face masks to patients showing respiratory disease symptoms.

Recently, a novel coronavirus called COVID-19 has emerged as a major worldwide health threat. The World Health Organization (WHO) has declared COVID-19 to be a pandemic. Face masks are recommended when in close contact with others by almost all public health authorities worldwide, including the Centers for Disease Control (CDC) in the United States. In a vast majority of countries, face mask usage is mandated by law. Although face masks are believed to reduce the spread of respiratory diseases such as COVID-19, they are not without faults.

When wearing a face mask, breathing can become more difficult. This can affect those doing physical activity such as joggers, weight lifters, and those participating in team sports such as basketball, tennis, and soccer. Moreover, many people must now wear face masks all day long, such as restaurant employees, physicians, law enforcement officers, nurses, hair dressers, cosmetologists, grocery workers, teachers, students, and so forth. Wearing a face masks for extended period is uncomfortable, exacerbates perspiration, and for those who wear make-up, causes it to rub off.

### SUMMARY

A clip for facilitating face mask attachment on an eyewear is disclosed herein. The clip comprises a clip body having a temple attachment portion for facilitating placement of the clip on a temple of an eyewear, and a mask attachment portion extending from the temple attachment portion for securely holding a securing cord of a face mask.

In another embodiment, a mask attachment sleeve is disclosed herein. The mask attachment sleeve is configured for assembly on a temple of an eyewear. The mask attachment sleeve comprises a sleeve body, and at least one clip provided on the sleeve body for securely holding a securing cord of a face mask.

### BRIEF DESCRIPTION OF THE DRAWINGS

FIG. 1 shows a perspective view of a clip, according to a first embodiment of the present disclosure.

FIG. 2 shows a perspective view of the clip being assembled on an eyewear, according to the first embodiment of the disclosure.

FIG. 3 shows a perspective view of the clip assembled on an eyewear, according to the first embodiment of the disclosure.

FIG. 4 shows a perspective view of the clip assembled on an eyewear, according to the second embodiment of the disclosure.

FIG. 5 shows a perspective view of an eyewear including the clip provided on the eyewear, according to the third embodiment of the disclosure.

FIG. 6 illustrates a perspective view of a mask attachment sleeve being assembled on an eyewear, according to the fourth embodiment of the disclosure.

FIG. 7 and FIG. 8 illustrate perspective views of a mask attachment sleeve being assembled on an eyewear, according to the fifth embodiment of the disclosure.

FIG. 9 and FIG. 10 illustrate schematic views of usage of the mask attachment clips, according to the embodiments of the disclosure.

### DETAILED DESCRIPTION OF EXAMPLE EMBODIMENTS

Example embodiments of the disclosure now will be described more fully hereinafter with reference to the accompanying drawings, in which example embodiments are shown. The concepts discussed herein may, however, be embodied in many different forms and should not be construed as limited to the example embodiments set forth herein; rather, these embodiments are provided so that this disclosure will be thorough and complete, and will fully convey the scope to those of ordinary skill in the art. Like numbers refer to like elements but not necessarily the same or identical elements throughout.

In accordance with an embodiment of the present disclosure, a clip is disclosed that allows a user to wear face masks for long durations without causing any irritation to the user. More specifically, using the clip, as disclosed herein, the user does not need to place the face mask cords behind their ears. The clip, in accordance with an embodiment of the present disclosure, may be attached to or mounted on a temple of an eyewear such as a spectacle and hold the cords of a facemask therein, thereby allowing the user to attach the mask cords to the clip instead of behind the user's ear and thus eliminating the discomfort associated with having the cords of the mask behind the user's ear for long durations.

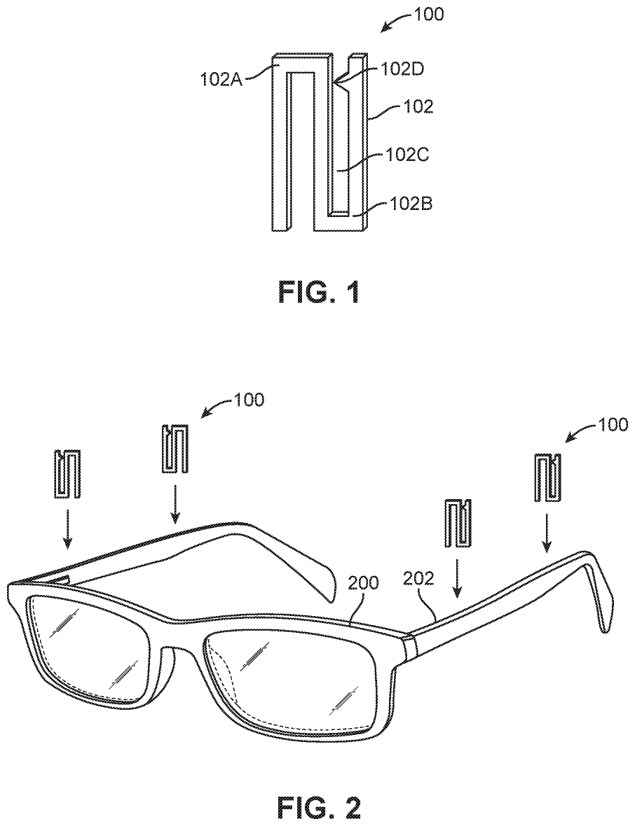

Referring to FIG. 1, a perspective view of a clip 100, according to a first embodiment of the present disclosure, is illustrated. As seen in FIG. 1, the clip 100 comprises a clip body 102 which is defined by a temple attachment portion 102A and a mask attachment portion 102B. The temple attachment portion 102A is configured for placement of the clip 100 on a temple of an eyewear. The mask attachment portion 102B extends from the temple attachment portion 102A and configured for holding a securing cord of a face mask. In accordance with an embodiment of the present disclosure, both the temple attachment portion 102A and the mask attachment portion 102B have a substantially U-shaped configuration. In one embodiment, the temple attachment portion 102A and the mask attachment portion 102B are integrally molded and together define an S-shaped profile. The mask attachment portion 102B, that extends from the temple attachment portion 102A, defines a slot 102C, wherein the slot 102C may hold a face mask cord. The clip 100 further comprises a tab 102D, wherein the tab 102D is provided on the mask attachment portion 102B to prevent the face mask stings or straps to get displaced out of the mask attachment portion 102B accidentally

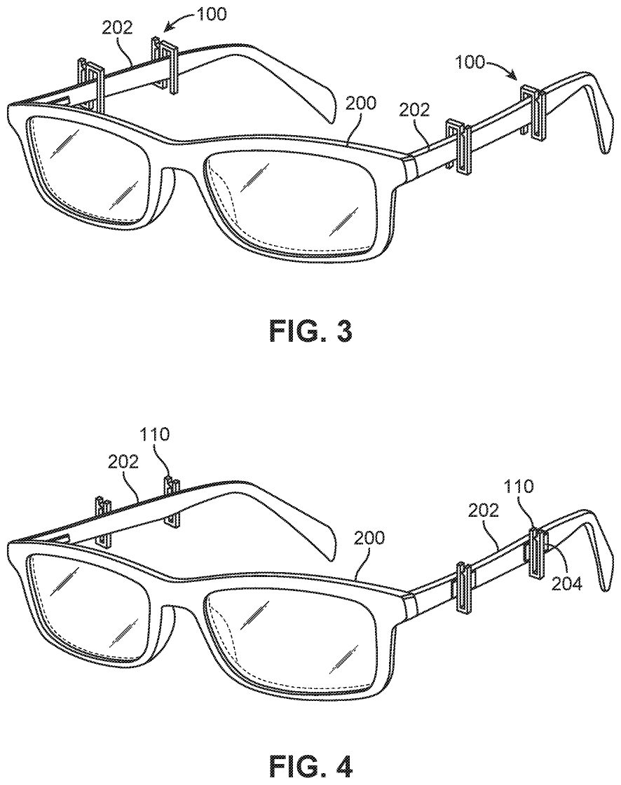

Referring to FIG. 2 and FIG. 3, perspective views of the clip 100 being assembled on an eyewear 200, according to the first embodiment of the disclosure, are illustrated. The temple attachment portion 102A can be fitted over a temple 202 of the eyewear 200. The arrows A indicate the method of fitting the clip 100 on the temples 202 of the eyewear 200. It may be noted that eyewear 200 may be user's prescription glasses, reading glasses, safety goggles, or sunglasses. In general, eyewear as used herein is to be construed broadly to encompass any device having a frame that rests on the nose and ears. In one embodiment, each temple 202 may include one or more clips 100 being assembled thereon.

Referring to FIG. 4, a perspective view of the clip assembled on an eyewear, according to the second embodiment of the disclosure, is illustrated. The clip 110 depicted in FIG. 4 is a different embodiment of the clip 100. The clip 110 does not include the temple attachment portion. The attachment of the clip 110 to the temple 202 of the eyewear 200 is facilitated via attachment means 204. In accordance with one embodiment, the attachment means 204 may be one of a double-sided adhesive tape and an adhesive. In one embodiment, each temple 202 may include one or more clips 110 being assembled thereon.

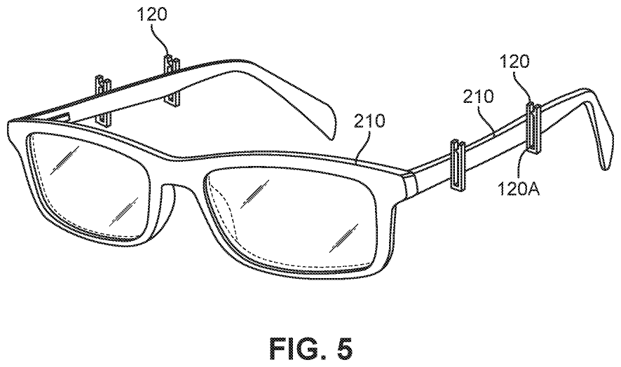

Referring to FIG. 5, a perspective view of an eyewear including the clip provided on the eyewear, according to the third embodiment of the disclosure. As seen in FIG. 5, the eyewear 210 may be a type of a safety goggle that is configured to allow attachment of a mask cord thereto. More specifically, the eyewear 210 includes the clips 120 provided on the temple 212 thereof. The clips 120 and the temple 212 are integral and may be molded as a single component. Similar to the configuration of clip 110, the clip 120 defines a slot 120A for allowing a cord of a facemask to be inserted therein. The tab 120D prevents the accidental displacement of the cord from the slot 120A.

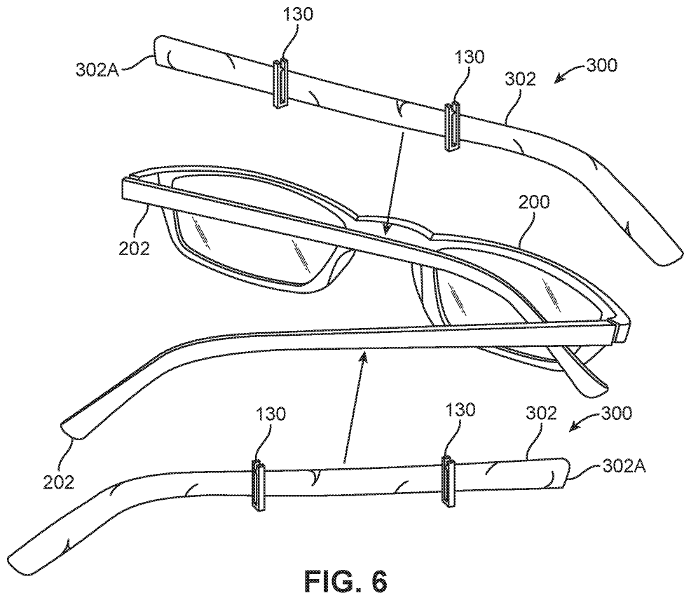

Referring to FIG. 6, a perspective view of a mask attachment sleeve 300 being assembled on an eyewear, according to the fourth embodiment of the disclosure, is illustrated. The mask attachment sleeve 300, as the name suggests, is a flexible sleeve that can be put on the temple 202 of the eyewear 200 like a cover. The mask attachment sleeve 300 includes a sleeve body 302 and at least one clip 130 provided on the sleeve body 302. More specifically, the sleeve body 302 defines a substantially hollow cylindrical configuration with at least one open end 302A in which the temple 202 may be inserted. In one embodiment, the clip 130 may have a configuration similar to that of clip 110. In one embodiment, the mask attachment sleeve 300 may be made of a malleable sheet material, wherein the malleable sheet material may be one of a fabric sheet and a plastic sheet.

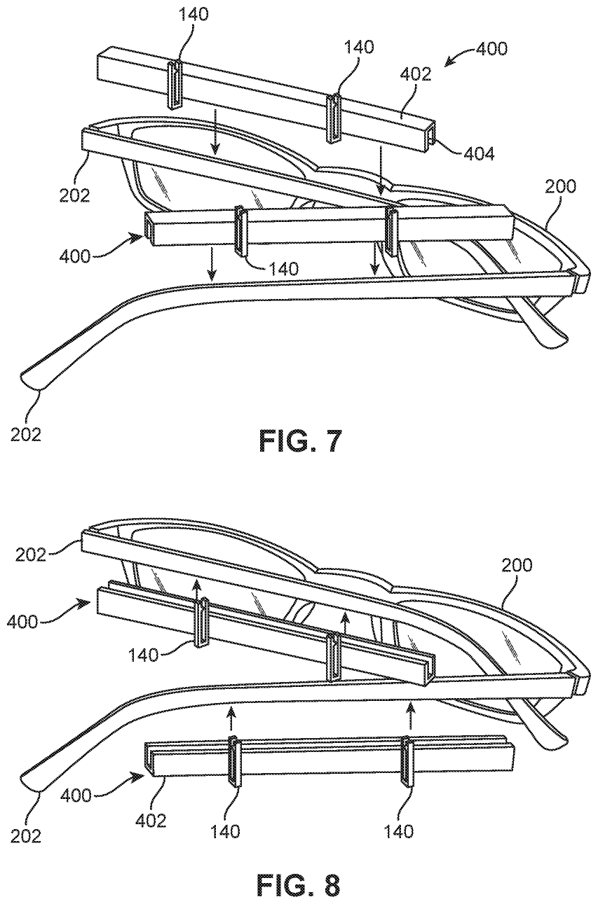

Referring to FIG. 7 and FIG. 8, perspective views of a mask attachment sleeve 400 being assembled on an eyewear 200, according to the fifth embodiment of the disclosure, are illustrated. The mask attachment sleeve 400 is made of a rigid material. The mask attachment sleeve 400 includes a sleeve body 402. At least one clip 140 is provided on the sleeve body 402. The configuration of the clip 140 may be similar to that of clips 110 and 130. The sleeve 400 further comprises a slot 404 extending along the length of the sleeve body 402. The slot 404 is configured to snugly fit onto the temples 202 of the eyewear 200.

In one embodiment, as seen in FIG. 7, the mask attachment sleeve 400 may be mounted on an operative top edge of the temple 202. In another embodiment, as seen in FIG. 8, the mask attachment sleeve 400 may be mounted to the operative bottom edge of the temple 202.

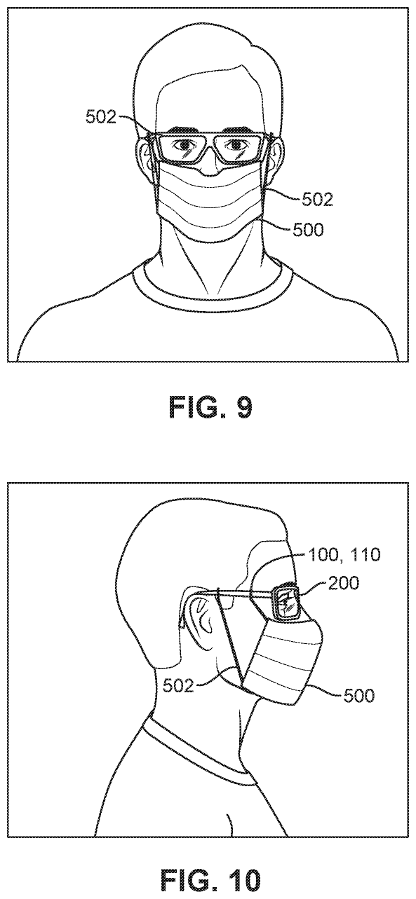

Referring to FIG. 9 and FIG. 10, schematic views of usage of the mask attachment clips 100, 110, 130, according to the embodiments of the disclosure, are illustrated. As seen in FIG. 9 and FIG. 10, the user does not have to put cords 502 of a mask 500 behind the user's ear. Having the cord 502 pushing onto backside of the ear for long durations causes pain and discomfort. The aforementioned disadvantageous aspect is overcome by the embodiments envisaged in the present disclosure by allowing the user to attach the cords 502 of the mask 500 onto the temple 202 of the eyewear 200.

Although the features, functions, components, and parts have been described herein in accordance with the teachings of the present disclosure, the scope of coverage of this patent is not limited thereto. On the contrary, this patent covers all embodiments of the teachings of the disclosure that fairly fall within the scope of permissible equivalents.

Many modifications and other implementations of the disclosure set forth herein will be apparent having the benefit of the teachings presented in the foregoing descriptions and the associated drawings. Therefore, it is to be understood that the disclosure is not to be limited to the specific implementations disclosed and that modifications and other implementations are intended to be included within the scope of the appended claims. Although specific terms are employed herein, they are used in a generic and descriptive sense only and not for purposes of limitation.

What is claimed is:

1. A clip comprising:
a clip body having:
a temple attachment portion for facilitating placement of the clip on a temple of an eyewear; and
a mask attachment portion extending from the temple attachment portion for securely holding a securing cord of a face mask.

2. The clip according to claim 1, wherein the temple attachment portion has a substantially U-shaped configuration.

3. The clip according to claim 1, wherein the mask attachment portion has a substantially U-shaped configuration.

4. The clip according to claim 1, wherein the temple attachment portion and the mask attachment portion are integrally molded.

5. A clip comprising a clip body having a substantially U-shaped configuration that defines a mask attachment portion, wherein the clip is attachable to a temple of an eyewear via at least one attachment means and configured for securely holding a securing cord of a face mask.

6. The clip according to claim 5, wherein the at least one attachment includes at least one of an adhesive and a double-sided adhesion tape.

7. A mask attachment sleeve for assembly on a temple of an eyewear, the mask attachment sleeve comprising:
a sleeve body;
at least one clip provided on the sleeve body for securely holding a securing cord of a face mask therewithin.

8. The mask attachment sleeve according to claim 7, further comprising a groove defined along a length of the sleeve body to facilitate fitment of the sleeve body on the temple of the eyewear.

9. The mask attachment sleeve according to claim 7, wherein the sleeve body is made of a malleable sheet having a hollow substantially cylindrical configuration and defining at least one hole for receiving the temple of the eyewear.

10. The mask attachment sleeve according to claim 9, wherein the malleable sheet is at least one of a fabric material and a plastic material.
